(19) United States
(12) Patent Application Publication
(10) Pub. No.: US 2009/0072165 A1
(43) Pub. Date: Mar. 19, 2009

(54) FLEXIBLE WORK AND UTILITY LAMP

(76) Inventor: James L. Townsend, Madison, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/857,015

(22) Filed: Sep. 18, 2007

(51) Int. Cl. F21S 10/00; F21S 4/00; G01J 3/10; B60Q 1/26

(52) U.S. Cl. 250/504 R; 116/202; 362/232

(57) ABSTRACT

A rope light is provided comprising a plurality of infrared lamps that enable a user to stealthily operate the light under cover of darkness. The method of using the rope light comprises either signaling to an observer or operating on a workpiece. The rope light can be positioned to signal information such as the outlines of a runway or supply drop point. The observer, using appropriate goggles or other visualization devices, can then detect such signals. The rope light provided can also be used to operate on such things as an automobile engine under cover of darkness. The rope light can be flexibly positioned in such things as engine compartments to flood the compartment with infrared light, enabling a person to repair a workpiece such as an engine. Other embodiments use a rope light that radiates light visible to the human eye for both signaling and operating on a workpiece.

### FIELD OF THE INVENTION

The present invention is generally related to illumination, and more particularly, but not exclusively, is related to infra-red illumination devices that can be used in rugged environments.

### BACKGROUND OF THE INVENTION

Rope lights are used in a number of applications, and are sometimes heavily used in commercial settings such as advertising, in other settings such as interior decorating, or in art, to name just a few. In these applications the rope lights can be configured in any of a variety of shapes, many of which are meant to attract the eye or make a statement. The individual lamps in these lights can emit a range of colors, either through careful selection of the individual lamps used in the rope lights, or through the use of colored covering.

In many applications rope lights can be used indoors, but other applications may employ the lights in outdoor settings, such as during holiday seasons where some rope lights come in a variety of colors and have blinking lights. While some rope lights are designed for indoor use but are nevertheless used outdoors, some rope lights are specifically made to be used in the outdoors.

Though there are different types of rope lights and different settings in which the lights are used, the potential for other methods of using such lights has not been exhausted. Accordingly, the present invention addresses further methods of using rope lights.

### SUMMARY OF THE INVENTION

The present invention provides systems and techniques for providing use-specific illumination. While the actual nature of the invention covered herein can only be determined with reference to the claims appended hereto, certain aspects of the invention that are characteristic of the embodiments disclosed herein are described briefly as follows.

According to one aspect, a method of signaling is disclosed, comprising the steps of a) providing a rope light comprising an elongate flexible covering; a power adapter; a plurality of lamps disposed within the elongate flexible covering and operably connected to the power adapter; b) connecting the power adapter to a power source; c) providing power to the lamps; d) positioning the rope light as an indicator; and e) signaling to an observer.

In another aspect, a method of operating on a workpiece under cover of darkness is disclosed, the method comprising the steps of a) providing a rope light comprising: an elongate flexible covering; a power adapter; a plurality of lamps that emit substantially only infrared illumination disposed within the elongate flexible covering and operably connected to the power adapter; b) connecting the power adapter to a power source; c) positioning the rope light to illuminate a workpiece; d) providing infrared visualization equipment to an operator; e) observing the workpiece using the infrared visualization equipment; and f) operating on the workpiece.

In yet another aspect, a method of indicating a landing area for airborne items is disclosed, the method comprising the steps of: a) providing a rope light comprising: an elongate flexible covering; a power adapter; a plurality of lamps that emit substantially only infrared illumination disposed within the elongate flexible covering and operably connected to the power adapter; b) connecting the power adapter to a power source; c) positioning the rope light to illuminate a boundary of a landing area; and d) observing the rope light from an aircraft using infrared visualization equipment.

These and other aspects are discussed below.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying figures forming a part thereof.

FIG. 1 is a schematic diagram of a rope light.

FIG. 2 is a schematic flowchart diagram showing a method of using a rope light to signal an observer.

FIG. 3 is a schematic flowchart diagram showing a method of using an infrared rope light to illuminate a workpiece.

### DESCRIPTION OF PREFERRED EMBODIMENTS

While the present invention may be embodied in many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

In one form, the present invention provides a rope light capable of use as a position indicator in low visibility conditions or in total darkness. The rope light can be composed of LED lamps that emit electromagnetic radiation in the infrared region of the spectrum. While not visible to the ordinary human observer, an observer using active night vision goggles, or any other suitable type of infrared wavelength visualization device, is capable of sensing the infrared illumination emitted by the rope light. Furthermore, the rope light can be configured in a unique pattern or geometric shape that will cause it to stand out upon being detected by the observer.

In another form, the present invention provides a water-tight rope light capable of use in underwater operations such as when repairing sea-going vessels. High luminance LEDs can be used in these applications to provide sufficient lighting to make underwater repairs. Because of its flexibility, the rope light can be positioned in a wide variety of configurations for optimum use.

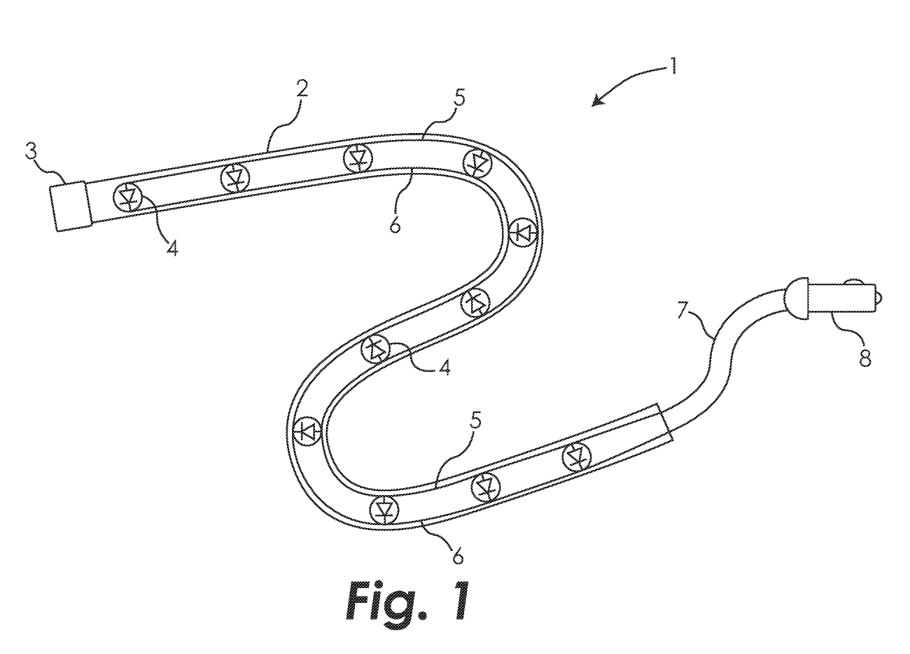

Turning now to the figures, FIG. 1 schematically illustrates one type of rope light for use with the various embodiments disclosed herein. The rope light is indicated generally at 1 and includes an elongate flexible covering 2, typically made from a flexible plastic tubing. One end of the flexible covering 2 is closed by an end closure 3 which keeps debris and, preferably, water and moisture out of the interior of elongate flexible covering 2. In some embodiments, the end closure 3 is integral with the elongate flexible covering 2. Disposed within the elongate flexible covering 2 are one or more light sources 4 conductively coupled in parallel by conductors 5 and 6. In some embodiments, the light sources 4 comprise light emitting diodes (LEDs). In other embodiments, the LEDs 4 emit light primarily in the infrared spectrum. In some embodiments, the light sources 4 are coupled in a serial fashion. Conductors 5 and 6 exit the elongate flexible covering 2 in a cord 7. The transition between elongate flexible covering 2 and cord 7 is preferably sealed to prevent entry of debris and moisture into the elongate flexible covering 2. Cord 7 is adapted to facilitate coupling of the conductors 5 and 6 to a source of power (not shown). In one embodiment, cord 7 is terminated with a plug 8 adapted for coupling to a standard cigarette lighter in a vehicle.

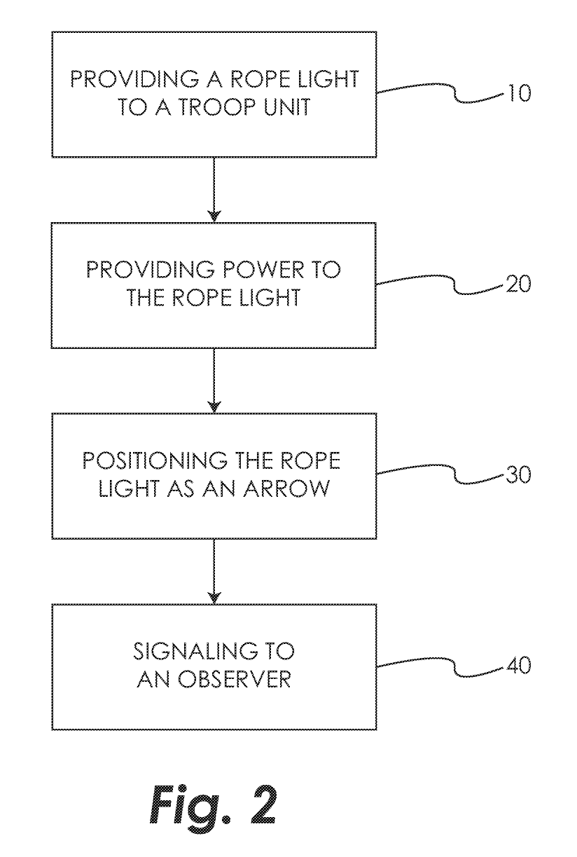

Referring now to FIG. 2, there is schematically depicted a method of using an infrared rope light for purposes of stealthily signaling information to and/or from a military troop unit. A flexible and rugged rope light 1 can be provided in step 10. Preferably, the rope light is made of a rugged construction such as would allow a vehicle to be driven over it without damage to its operability. The construction is preferably also be made rugged enough for whatever harsh military applications within which the troop unit may be operating.

A number of infrared lamps 4 are operably connected to the power adapter 8 and can be disposed within the elongate flexible shell 2 and arranged in a linear fashion. In some embodiments the lamps 4 may be bunched together, forming groupings of regular or irregular patterns. In some embodiments the elongate flexible shell 2 can be hundreds of feet in length and may be provided on a heavy duty spool that can be easily transported to a theater of operation.

The rope light is powered in step 20 by connecting the power adaptor 8 to a power supply such as a cigarette lighter in a vehicle, or a battery (just to name two non-limiting examples), whereupon the lamps become illuminated. A switch may be provided in some embodiments that permits the lamps to be selectively powered “on” or “off” at the discretion of the troop unit, or in other embodiments the lamps may be automatically powered “on” when the power adaptor 8 is connected to the power supply. In still other embodiments, a circuit may be provided to switch power “on” and “off” in either regular or random intervals.

The troop unit may position the rope light in step 30 to take the form of an indicator, such as any geometric shape or irregular contour. For example, if the troop unit wishes to alert friendly forces to the location of an enemy encampment, the rope light might take the form of an arrow which points in the direction of the encampment. The troop unit may furthermore dynamically change configuration of the rope light, thereby communicating time-varying information, such as reconfiguring an arrow to track a slowly moving target. In other applications the rope light might be in a spool hundreds of feet in length, for example, that could be laid down for guidance of aircraft for landing zones, landing strips, and/or equipment drop zones. A small spool of fifty feet, for example, can also be used to mark a safe zone within which paratroopers may land. Certain embodiments may be used to mark an area for Navy SEALs to land in. Pilots may also carry small versions in their survival kits that can be used as a rescue aid that can be arranged in a unique pattern and visible only to friendly forces. In such embodiments, the rope light 1 would include portable battery power.

Once the rope light 1 has been configured as an indicator at step 30, the troop unit may activate the lamps, thus signaling to an observer whatever pertinent information is intended, as shown in step 40. An observer may detect the infrared rope light 1 when using special receiving equipment, such as infrared visualization goggles, to name just one nonlimiting example. When using infrared lamps 4 in the rope light 1, observers without infrared visualization equipment will not be able to observe the rope light 1. In other embodiments the troop unit may signal to an observer by selectively placing an obstruction over the rope light, such as vegetation or a canvas cloth, as opposed to selectively activating the lamps. In further embodiments, the troop unit may wave the rope light in a repetitive or random movement.

The steps mentioned in FIG. 1 need not occur in the order listed. For example, in some embodiments the troop unit may position the rope light 1 before providing power to it. Such would be desirable to maximize the clandestine period in which the unit is operating. In addition, some steps may be repeated multiple times, such as positioning the rope light 1 in a different configuration in between activation of the lamps 4. A troop unit may wish to communicate a complex message that requires multiple rope light 1 activations interspersed with multiple changes in configuration of the rope light 1. In other situations, the troop unit may wish to maneuver the rope light 1 to track a slow moving object or other slowly changing movement.

In some embodiments, the lamps 4 need not provide infrared illumination but, rather, may provide illumination at a wavelength visible to the human eye. Rope lights 1 in these applications can be used as a warning light positioned near a disabled vehicle so as to signal to oncoming motorists of the upcoming hazard. In this application, the lamps can be multi-colored and may blink on and off, thus heightening a motorist's attention to the hazard. The same steps as outlined in FIG. 2 can be used when signaling to an observer using a rope light 1 that emits visible electromagnetic radiation.

In some applications it may be desired to stealthily illuminate an object rather than signaling to an observer. The infrared aspects of the rope light 1 make it suitable to illuminating objects under the cover of darkness. For example, a military convoy moving under the cover of darkness may need to stop and make repairs on a distressed vehicle. In this situation, a properly equipped soldier may be able to make repairs without flooding the engine compartment (or other area of the vehicle) with visible light through the use of an infrared rope light 1 used in conjunction with infrared visualization goggles, thereby preserving some element of stealth as repairs are carried out.

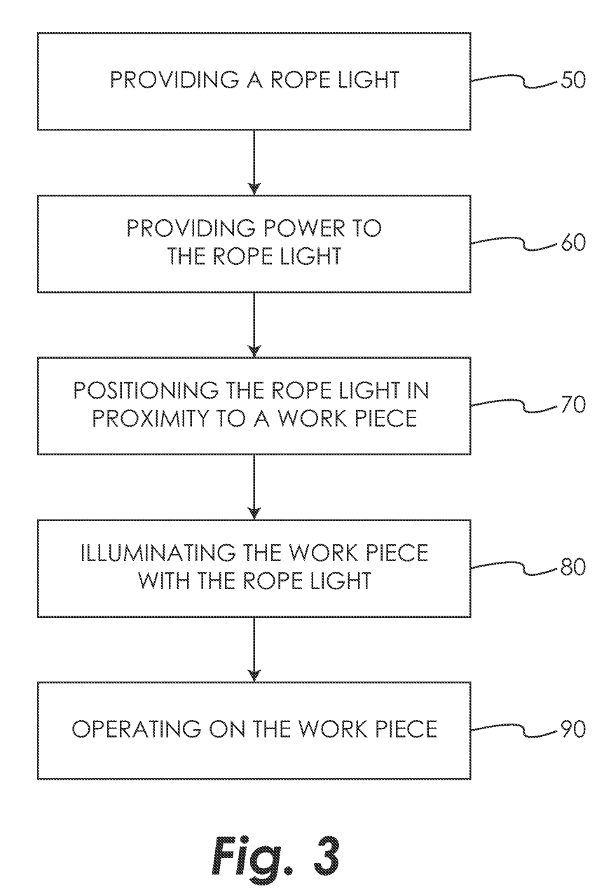

FIG. 3 depicts an alternative method of using an infrared LED rope light 1 wherein a mechanic outfitted with special goggles can use the light to illuminate a work piece in the dark, thereby allowing repairs to be made under the cover of darkness. A flexible and rugged rope light 1 emitting infrared illumination is provided in step 50. Power is provided to the rope light 1 in step 60, which may cause either automatic or selective illumination depending on whether a switch is incorporated into the light.

A mechanic positions the rope light 1 in proximity to a workpiece such as an engine, as depicted in step 70. Because the rope light 1 is flexible, it may be positioned such that it is routed through and/or around certain engine compartment components, thus providing wide and perfuse lighting coverage, as opposed to a lighting device having a single lamp that may be inadequate in some situations to fully flood an engine compartment with light. The rope light 1 disclosed herein, therefore, may provide a superior choice in some applications because of its ability to provide light over a wide and irregular area.

When desired, the mechanic can illuminate the workpiece with the infrared light emanating from the rope light 1 as shown in step 80, either by proper positioning of the rope light 1 after it has been activated or by selectively providing power to the lamps. The illuminated workpiece can be visualized by the mechanic through special goggles or through other visualization equipment (such as night vision goggles). After the mechanic has provided infrared illumination, repairs can be made under the cover of darkness by operating on the workpiece, as disclosed in step 90.

In other embodiments, the LED lamps need not provide infrared illumination but, rather, may provide illumination at a wavelength visible to the human eye. Rope lights in these applications can be used using steps outlined above in FIG. 3 for performing many tasks such as working under the hood of a vehicle, changing a tire, or, as mentioned above, making submarine repairs, to name just a few. Furthermore, infrared rope lights may be used for clandestine underwater operations by divers wearing infrared visualization equipment.

The steps mentioned in FIG. 3 need not occur in precisely the order listed. For example, a mechanic may position the rope light before providing power to it. In addition, some steps may be repeated such as positioning the rope light, illuminating a workpiece, and then repositioning the rope light.

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding. Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Likewise, where the term “input” or “output” is used in connection with an electric device or fluid processing unit, it should be understood to comprehend singular or plural and one or more signal channels or fluid lines as appropriate in the context. Finally, all publications, patents, and patent applications cited in this specification are herein incorporated by reference to the extent not inconsistent with the present disclosure as if each were specifically and individually indicated to be incorporated by reference and set forth in its entirety herein.

What is claimed is:

1. A method of signaling comprising the steps of:
a) providing a rope light comprising:
an elongate flexible covering;
a power adapter;
a plurality of lamps disposed within the elongate flexible covering and operably connected to the power adapter;
b) connecting the power adapter to a power source;
c) providing power to the lamps;
d) positioning the rope light as an indicator; and
e) signaling to an observer.

2. The method of claim 1 wherein providing a rope light comprises a plurality of lamps emitting infrared illumination.

3. The method of claim 2, further comprising the step of:
e) observing the rope light using infrared visualization equipment.

4. The method of claim 1 wherein signaling is selected from the group consisting of:
(1) selectively activating the rope light; (2) placing a cover over the rope light; and (3) waving the rope light.

5. The method of claim 1 wherein providing the rope light includes packaging the rope light in a spool.

6. A method of operating on a workpiece under cover of darkness, the method comprising the steps of:
a) providing a rope light comprising:
an elongate flexible covering;
a power adapter;
a plurality of lamps that emit substantially only infrared illumination disposed within the elongate flexible covering and operably connected to the power adapter;
b) connecting the power adapter to a power source;
c) positioning the rope light to illuminate a workpiece;
d) providing infrared visualization equipment to an operator;
e) observing the workpiece using the infrared visualization equipment; and
f) operating on the workpiece.

7. The method of claim 6 wherein step (b) further comprises the step of coupling the power adaptor to a vehicle cigarette lighter.

8. The method of claim 7, wherein the workpiece is a vehicle.

9. The method of claim 8, wherein operating on the workpiece is selected from the group consisting of: (1) repairing an engine; and (2) changing a tire.

10. The method of claim 6 wherein providing the rope light includes packaging the rope light in a spool.

11. A method of indicating a landing area for airborne items, the method comprising the steps of:
a) providing a rope light comprising:
an elongate flexible covering;
a power adapter;
a plurality of lamps that emit substantially only infrared illumination disposed within the elongate flexible covering and operably connected to the power adapter;
b) connecting the power adapter to a power source;
c) positioning the rope light to illuminate a boundary of a landing area; and
d) observing the rope light from an aircraft using infrared visualization equipment.

12. The method of claim 11 wherein providing the rope light includes packaging the rope light in a spool.

13. The method of claim 11, wherein the landing area is selected from the group consisting of (1) a landing strip, (2) a paratrooper landing zone and (3) an equipment drop zone.
